(19) United States
(12) Patent Application Publication
(10) Pub. No.: US 2008/0095249 A1
(43) Pub. Date: Apr. 24, 2008

(54) Apparatus and method for estimating coarse carrier frequency offset for frequency synchronization in OFDM receiver

(75) Inventors: Su-Jin Yoon, Suwon-si (KR); Yun-Ju Kwon, Suwon-si (KR); Hee-Jin Roh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/645,743

(22) Filed: Dec. 27, 2006

(30) Foreign Application Priority Data
Dec. 27, 2005 (KR) 2005-130849

(51) Int. Cl. H04K 1/10

(52) U.S. Cl. 375/260

(57) ABSTRACT

An apparatus and method for estimating a coarse carrier frequency offset in an OFDM receiver are provided, in which an Fast Fourier Transform (FFT) unit performs FFT for a received signal over one symbol duration and outputs a previously known signal included in the FFT signal, a correlation value calculator evaluates autocorrelation values of the previously known signal for plural candidate offsets, an accumulator accumulates the autocorrelation values to the autocorrelation values evaluated over a previous symbol duration, and a maximum value selector selects first and second maximum values of the autocorrelation values. A threshold tester compares a ratio between the first and second maximum values with a predetermined threshold, and determines a candidate offset corresponding to the first maximum value as the coarse carrier frequency offset if the ratio is less than the threshold. Otherwise, the threshold tester instructs the FFT unit to receive a signal over a next symbol duration.

### CROSS-REFERENCE TO RELATED PATENT APPLICATION

This application claims the benefit under 35 U.S.C. § 119(a) of a Korean Patent Application filed in the Korean Intellectual Property Office on Dec. 27, 2005 and assigned Serial No. 2005-130849, the entire disclosure of which is hereby incorporated by reference.

### BACKGROUND OF THE INVENTION

1. Field of the Invention

The present invention relates to an Orthogonal Frequency Division Multiplexing (hereinafter referred to as “OFDM”) system. More particularly, the present invention relates to an apparatus and a method for estimating a coarse carrier frequency offset in an OFDM receiver.

2. Description of the Related Art

Recently, OFDM transmission technology has been widely employed as radio access technology in a broadcast system and a mobile communication system. The OFDM technology removes interference between multi-path signal components commonly existing in a radio communication channel, ensures orthogonality between multiple access users, and enables frequency resources to be efficiently used, by reason of which it is useful for high speed data transmission and a broadband communication system as compared with Code Division Multiple Access (hereinafter referred to as “CDMA”) technology. The OFDM technology using a multi-carrier for data transmission is a type of Multi-Carrier Modulation (hereinafter referred to as “MCM”) scheme in which a serial input data symbol string is converted into parallel data symbols, and respective parallel data symbols are carried by a plurality of sub-carriers, that is, a plurality of sub-carrier channels, which have mutual orthogonality.

In the OFDM transmission scheme, transmitting in parallel data symbols through sub-carriers maintaining mutual orthogonality is simply achieved using a Fast Fourier Transform (hereinafter referred to as “FFT”). Since such an OFDM scheme can more efficiently use a transmission band than a single carrier modulation scheme, it is mainly applied to a broadband transmission scheme.

The OFDM transmission scheme exhibits a reception characteristic that is robust against a frequency selective multi-path fading channel as compared with a single carrier transmission scheme. This is because a band occupied by a plurality of sub-carriers becomes a frequency selective channel, but a band occupied by each sub-carrier becomes a frequency non-selective channel, which makes it possible to easily perform channel compensation for a reception signal through a simple channel equalization process in a receiver. Particularly, the OFDM transmission scheme removes Inter-Symbol Interference (hereinafter referred to as “ISI”) from a previous OFDM symbol by attaching a Cyclic Prefix (hereinafter referred to as “CP”), a copy of a rear part of each OFDM symbol, to a header of the corresponding OFDM symbol before transmission. On this account, the OFDM transmission scheme is very suitable for high speed broadband communication.

In digital broadcasting standards, the OFDM transmission scheme has been in the spotlight as a transmission technique capable of ensuring high reception quality and high speed transmission and reception. An example of the digital broadcasting standards employing the OFDM transmission scheme includes Digital Audio Broadcasting (hereinafter referred to as “DAB”) for European wireless radio broadcasting, and Terrestrial Digital Video Broadcasting (hereinafter referred to as “DVB-T”) which is a terrestrial High Definition Television (hereinafter referred to as “HDTV”) standard.

Keeping pace with a trend of fusing broadcasting and communication, portable mobile broadcasting systems have recently been developed all over the world. Particularly, with a main object of transmitting mass capacity multimedia data under a mobile channel environment, DVB-H (Handheld) evolving from the DVB-T has been established as a portable mobile broadcasting standard in Europe, and Digital Multimedia Broadcasting (hereinafter referred to as “DMB”) evolving from the DAB has been established as a broadcasting standard in Korea. In addition, various communication standards based on the OFDM transmission scheme have also been developed.

A synchronization algorithm of the OFDM system is roughly divided into a carrier frequency synchronization algorithm and a symbol timing synchronization algorithm. Of the synchronization algorithms, the carrier frequency synchronization algorithm performs a function of estimating a carrier frequency offset between a transmitter and a receiver, and correcting a carrier frequency based on the estimated carrier frequency offset. The carrier frequency offset occurs due to a difference between oscillation frequencies of a transmitter and a receiver, and a Doppler frequency offset. The carrier frequency offset of a signal input to a receiving end may be larger than sub-carrier spacing and, in such a case, a process of correcting a carrier frequency offset corresponding to any integer times of the sub-carrier spacing is called “coarse carrier frequency synchronization.” In contrast, a process of correcting a carrier frequency offset smaller than the sub-carrier spacing is called “fine carrier frequency synchronization.” Since an offset corresponding to any integer times of the sub-carrier spacing shifts an OFDM signal by the corresponding integer times of the sub-carrier spacing in a frequency domain, FFT outputs also correspondingly shift, which makes it difficult to decode data. On the contrary, an offset smaller than the sub-carrier spacing gives rise to interference between FFT outputs, which results in deterioration of Bit Error Rate (BER) performance. As is generally known in the art, OFDM systems suffer from performance deterioration resulting from carrier frequency offset relatively more than single carrier transmission systems.

In the OFDM system, a symbol prearranged between a transmitter and a receiver (hereinafter referred to as “prearranged symbol”) or a pilot signal is used for frequency and timing synchronization, channel estimation, and the like. This pilot signal or prearranged symbol generally consists of a sequence which, similar to a Pseudorandom Noise (hereinafter referred to as “PN”) sequence, can utilize an autocorrelation characteristic. FIG. 1 illustrates the autocorrelation characteristic of a pilot signal used in the DVB-H system, and FIG. 2 illustrates the autocorrelation characteristic of a Phase Reference Symbol (hereinafter referred to as “PRS”) which is a prearranged symbol used in the DAB system. In FIGS. 1 and 2, the abscissa axes denote the frequency offset of a sequence. As illustrated in the drawings, the pilot signal or the prearranged symbol consisting of a PN sequence has a maximum autocorrelation value at a sequence frequency offset of 0.

The most well-known algorithms of coarse carrier frequency synchronization using such a pilot signal or prearranged symbol are those proposed by Nogami and Taura. The algorithm proposed by Nogami is a scheme in which autocorrelation values of a PN sequence are detected in a frequency domain during the reception of a prearranged symbol, and a frequency offset value at which the autocorrelation value has the maximum value is estimated as a coarse carrier frequency offset. The algorithm proposed by Taura is a scheme in which a PN sequence is corrected in a frequency domain, the corrected PN sequence is converted into a time-domain sequence through IFFT (Inverse FFT), and then a frequency offset value which maximizes the magnitude of the converted sequence is estimated as a coarse carrier frequency offset. Both the schemes estimate a carrier frequency offset by using the maximum value of autocorrelation values.

FIG. 3 schematically illustrates a frequency estimation apparatus of the DVB-H system, which evaluates autocorrelation values according to frequency offsets and outputs an offset having the maximum autocorrelation value as a coarse carrier frequency offset.

Referring to FIG. 3, a received signal corresponding to one symbol is converted into a frequency-domain signal by means of an FFT unit 302. More specifically, the FFT unit 302 converts the received signal into a plurality of sub-carrier signals, and cyclically shifts the plurality of sub-carrier signals by an m-th candidate offset which is one of a plurality of predetermined candidate offsets, and then outputs a pilot signal of the cyclically shifted signals to a multiplier 304. As an example, the pilot signal refers to a signal having a predetermined pilot-band among the cyclically shifted signals corresponding to the overall frequency band. The output pilot signal is designated by “z_{l,k}”, where “l” denotes a symbol index and “k” denotes a sub-carrier index.

The pilot signal z_{l,k} is delivered to the multiplier 304. The multiplier 304 multiplies the pilot signal z_{l,k} of a current symbol, output from the FFT unit 302, by the conjugate pilot signal z_{l-l,k} of a previous symbol, which is stored in a delayer 306, and outputs the resultant signal to an adder 308. The pilot signal z_{l,k} output from the FFT unit 302 is stored in the delayer 306 to be provided to the multiplier 304 when the next symbol is received. The delayer 306 has a capacity corresponding to the FFT size N_{fft} of the FFT unit 302, and can store a frequency-domain signal over one symbol duration.

The adder 308 adds up signals for a plurality of sub-carrier bands, which are output from the multiplier 304. When the received signal is subjected to QPSK (Quadrature Phase Shift Keying) modulation, an absolute value calculator 310 evaluates and outputs the absolute value, that is, magnitude of the resultant added-up signal. These operations are repeated for all of the plurality of candidate offsets, and autocorrelation values evaluated for the plurality of candidate offsets are input into a maximum value selector 312. The maximum value selector 312 then outputs a candidate offset corresponding to the maximum value among the autocorrelation values as a coarse carrier frequency offset Δfₘ. As described above, the coarse carrier frequency offset is an input for a carrier frequency synchronization algorithm, and is used for correcting a carrier frequency.

When the maximum value of autocorrelation values is evaluated only once as stated above, detection performance of a pilot signal or a prearranged symbol is lowered under a low Signal to Noise Ratio (hereinafter referred to as “SNR”) environment. FIG. 4 graphically illustrates the performance of detecting a carrier frequency offset when a frequency synchronization algorithm of performing correlation for a pilot signal in units of adjacent symbols is used in a typical DVB-H system. In FIG. 4, using a fixed time offset and a CP with a length of 1/32 in an Additive White Gaussian Noise (hereinafter referred to as “AWGN”) environment, detection performances obtained at a frequency offset of 0.00 and at a frequency offset of 0.25 (indicated by “FreqOff_{—}0.00” and “FreqOff_{—}0.25”, respectively) are compared with a BER obtained by QPSK modulation and viterbi decoding with a code rate of 0.5 (indicated by “viterbi BER”). It can be noted from the drawing that all of FreqOff_{—}0.00, FreqOff_{—}0.25 and viterbi BER show increased detection errors at low SNRs.

In general, initial synchronization performance must have priority over data decoding performance. Therefore, in order to satisfy such a requisite, more accurate and stable frequency synchronization technology is needed.

Accordingly, there is a need for an improved apparatus and method for detecting a carrier frequency offset in an OFDM receiver.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and a method for enhancing performance of detecting a carrier frequency offset and reducing an initial synchronization acquisition time in a coarse carrier frequency offset estimation system using an autocorrelation characteristic.

Exemplary embodiments of the present invention provide an apparatus and a method for estimating a coarse carrier frequency offset by using soft combining and threshold testing in an OFDM system.

In order to accomplish the above-mentioned object, in accordance with one aspect of exemplary embodiments of the present invention, there is provided an apparatus for estimating a coarse carrier frequency offset in an OFDM receiver, in which an FFT unit receives a signal corresponding to one symbol, fast Fourier transforms the received signal, and outputs a previously known signal included in the fast Fourier transformed signal; a correlation value calculator applies a plurality of predetermined candidate offsets to the previously known signal to thereby evaluate autocorrelation values of the previously known signal for the candidate offsets; an accumulator accumulates the evaluated autocorrelation values to autocorrelation values, which have been evaluated for the candidate offsets over a previous symbol duration, within a predetermined maximum accumulation count; a maximum value selector selects a first maximum value and a second maximum value from among the accumulated autocorrelation values; and a threshold tester compares a ratio of the second maximum value to the first maximum value with a predetermined threshold, determines a candidate offset corresponding to the first maximum value as the coarse carrier frequency offset if the ratio is less than the threshold, and instructs the FFT unit to receive a signal over a next symbol duration if the ratio is not less than the threshold.

In accordance with another aspect of exemplary embodiments of the present invention, there is provided a method for estimating a coarse carrier frequency offset in an OFDM receiver, in which, a signal corresponding to one symbol is received, the received signal is fast Fourier transformed, and a previously known signal included in the fast Fourier transformed signal is detected; a plurality of predetermined candidate offsets is applied to evaluate autocorrelation values of the previously known signal for the candidate offsets; the evaluated autocorrelation values are accumulated to autocorrelation values, which have been evaluated for the candidate offsets over a previous symbol duration, within a predetermined maximum accumulation count; a first maximum value and a second maximum value are selected from among the accumulated autocorrelation values, and whether a ratio of the second maximum value to the first maximum value is less than a predetermined threshold is determined; if the ratio is less than the threshold, a candidate offset corresponding to the first maximum value is determined as the coarse carrier frequency offset; and, if the ratio is not less than the threshold, the receiving step is repeated over a next symbol duration.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a graph illustrating an autocorrelation characteristic of a pilot signal used in a DVB-H system;

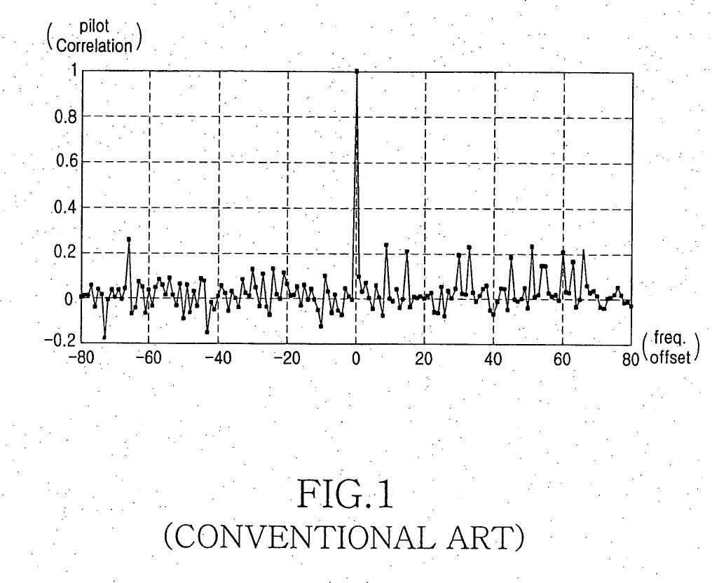

FIG. 2 is a graph illustrating an autocorrelation characteristic of a PRS in a DAB system;

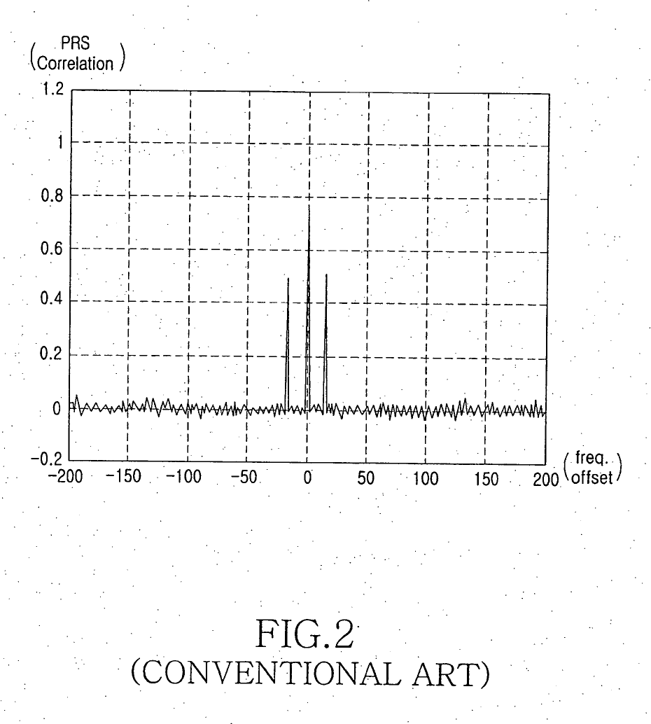

FIG. 3 is a block diagram schematically illustrating a frequency estimation apparatus of a DVB-H system;

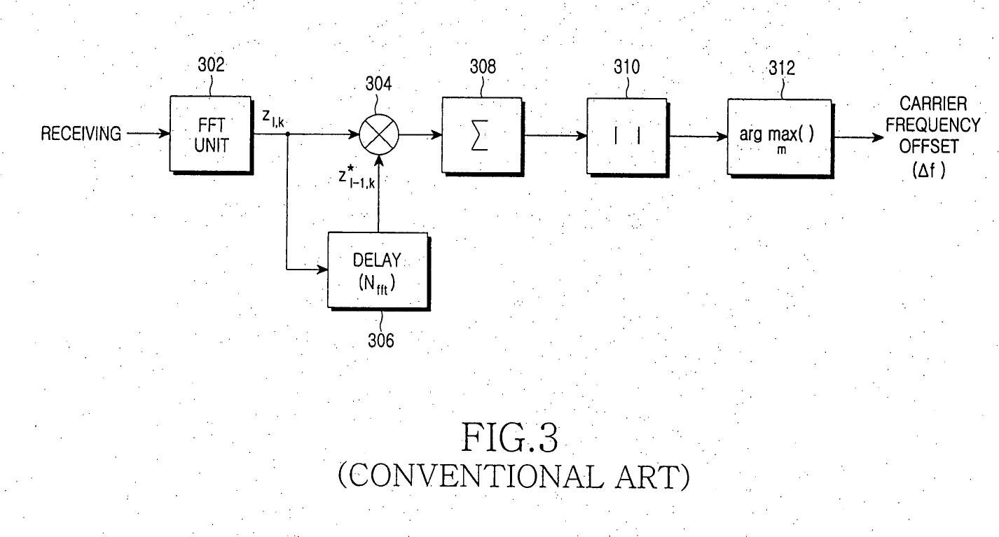

FIG. 4 is a graph illustrating the performance of detecting a carrier frequency offset in a typical DVB-H system;

FIG. 5 is a block diagram illustrating a frequency estimation apparatus in accordance with an exemplary embodiment of the present invention;

FIG. 6a is a flowchart illustrating a frequency estimation procedure in accordance with an exemplary embodiment of the present invention;

FIG. 6b is a flowchart illustrating a frequency estimation procedure in accordance with an exemplary embodiment of the present invention;

FIG. 7 is a graph illustrating the performance of detecting a carrier frequency offset when soft combining is performed;

FIG. 8 is a graph illustrating the performance of detecting a carrier frequency offset when adaptive soft combining dependent on threshold testing is performed in accordance with an exemplary embodiment of the present invention; and

FIG. 9 is a graph comparing an initial synchronization acquisition time in accordance with an exemplary embodiment of the present invention with that of a soft combining scheme.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention improve the performance of a coarse carrier frequency synchronization algorithm in detecting a coarse carrier frequency offset by using an autocorrelation characteristic between sub-carriers in an OFDM system.

The following two schemes described below are used for improving the performance of a coarse carrier frequency synchronization algorithm.

A first scheme is a soft combining scheme for improving detection performance. The soft combining scheme is a scheme of combining autocorrelation values which are evaluated at respective offsets for a plurality of received symbols, and requires a time of several symbol durations for the combining. If the number of times of performing soft combining increases in order to improve detection performance, the time required for detecting a frequency offset (that is, initial synchronization acquisition time) increases in proportion to the number of times of performing soft combining because the number of times of performing soft combining has a positive (+) correlation with frequency offset detection performance.

A second scheme is a scheme for ascertaining reliability, and is called “adaptive threshold testing.” In the adaptive threshold testing, a first maximum value and a second maximum value are obtained from autocorrelation values for a plurality of candidate offsets by using an autocorrelation characteristic between sub-carriers and, if a ratio between the first and second maximum values is less than a given threshold which can be experimentally established, detection is determined as a failure and thus will be reserved for another occasion. By using the adaptive threshold testing, synchronization detection performance can be enhanced. However, since a ratio not less than the threshold cannot be obtained in a low SNR environment, and thus reliability cannot be satisfied even if redetections are continually performed, frequency offset detection itself may become impossible. Nevertheless, the adaptive threshold testing provides excellent synchronization detection performance for higher SNRs.

Therefore, the above-described two schemes are joined together in an exemplary embodiment of the present invention, thereby providing a frequency synchronization algorithm excellent in synchronization detection performance and synchronization time.

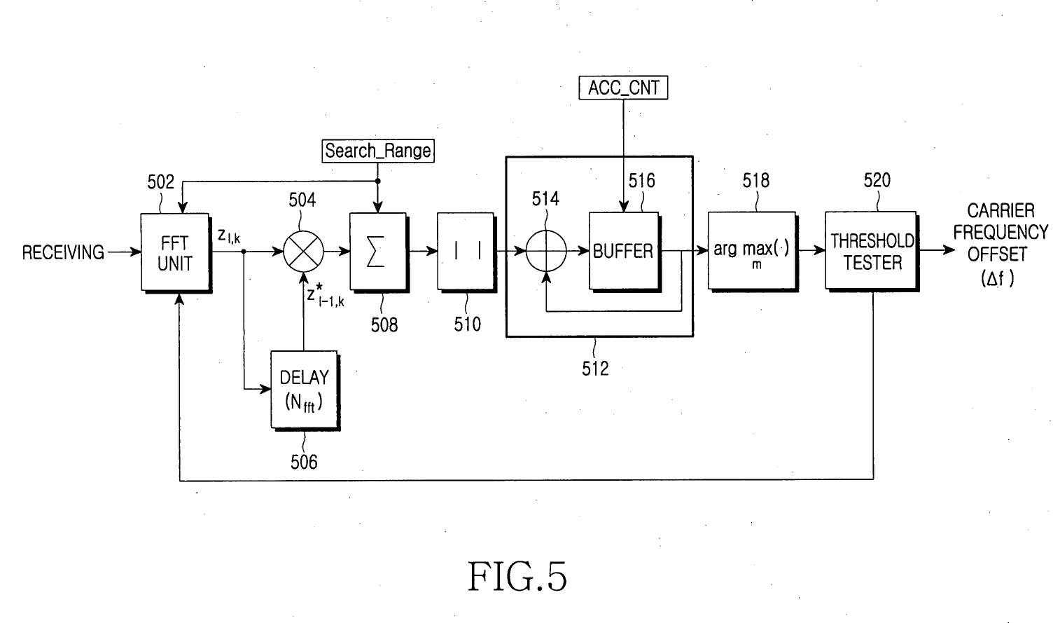

FIG. 5 illustrates a frequency estimation apparatus according to an exemplary embodiment of the present invention. A description will be given for using a pilot signal, but it is obvious that the same operations are applied using a prearranged symbol.

Referring to FIG. 5, a received signal corresponding to one symbol is converted into a frequency-domain signal by means of an FFT unit 502. For example, the FFT unit 502 converts the received signal into a plurality of sub-carrier signals corresponding to a plurality of sub-carrier bands, and cyclically shifts the plurality of sub-carrier signals by an m-th candidate offset which is one of a plurality of predetermined candidate offsets, and then outputs a pilot signal of the cyclically shifted signals to a multiplier 504. As an example, the pilot signal refers to a signal having a predetermined pilot-band among the cyclically shifted signals corresponding to the overall frequency band. When a frequency shift occurs by the inverse of a specific candidate offset, the pilot signal would be detected most strongly at a signal cyclically shifted by the specific candidate offset. The candidate offsets correspond to any integer times of sub-carrier spacing. The output pilot signal is designated by “z_{l,k}”, where “l” denotes a symbol index and “k” denotes a sub-carrier index.

The pilot signal z_{l,k} is delivered to the multiplier 504. The multiplier 504 together with a delayer 506 operates as a differential correlator, evaluates a correlation value by multiplying the pilot signal z_{l,k} of a current symbol, output from the FFT unit 502, by the conjugate pilot signal z*_{l-l,k} of a previous symbol, which is stored in the delayer 506, and outputs the evaluated correlation value to an adder 508. The pilot signal z_{l,k} output from the FFT unit 502 is stored in the delayer 506 to be provided to the multiplier 504 when the next symbol is received. The delayer 506 has capacity corresponding to the FFT size N_{fft} of the FFT unit 502, and can store a signal over the overall frequency domain of one symbol duration. The FFT size N_{fft} may be the same as the total number of sub-carriers, but a signal for some sub-carrier having effective data can be actually stored in the delayer 506.

The adder 508 adds up values output from the multiplier 504 during a predetermined search range, Search_Range, and outputs the added-up value as a correlation value for the pilot signal. In an exemplary implementation, Search_Range means the range of candidate offsets. As an example, if Search_Range is 30, correlation values for 60 candidate offsets from −30 to 30 are calculated. In the case of using QPSK, an absolute value calculator 510 evaluates and outputs the absolute value, that is, magnitude of the added-up signal by removing the minus (−) sign of the added-up signal. An accumulator 512 accumulates the correlation value provided by the absolute value calculator 510 and stores the correlation value in a buffer 516. At first, when the value is not stored in the buffer 516, an adder 514 doesn't operate. These operations are repeated for all of the plurality of candidate offsets, and correlation values evaluated for the plurality of candidate offsets are stored in the buffer 516. The correlation values are provided to a maximum value selector 518.

The maximum value selector 518 selects the largest value (a first maximum value) and the next largest value (a second maximum value) from among the provided correlation values. A threshold tester 520 determines if a ratio of the second maximum value to the first maximum value is equal to or greater than a predetermined threshold, threshold_ratio. The threshold, threshold_ratio, can be experimentally established according to required communication quality. If the ratio is less than threshold_ratio, the threshold tester 520 outputs a candidate offset corresponding to the first maximum value as a coarse carrier frequency offset Δfₘ. However, if the ratio is not less than threshold_ratio, the threshold tester 520 determines the first maximum value as unreliable and instructs the FFT unit 502 to receive the next symbol.

Under instructions from the threshold tester 520, the FFT unit 502 receives a signal over the next symbol duration, and a correlation value for the next symbol is input into the accumulator 512 through the same operations as those stated above. The adder 514 of the accumulator 512 adds the correlation value for the next symbol, provided by the absolute value calculator 510, to the correlation value of a previous symbol, which has been stored in the buffer 516, and provides the resultant added value to the buffer 516. The buffer 516 stores the added value provided by the adder 514 as a cumulative correlation value in substitute for the previously stored correlation value. Accordingly, by accumulating correlation values for a plurality of symbols, frequency synchronization performance can be improved even when a received SNR is large or frequency synchronization is affected by a frequency offset less than sub-carrier spacing.

The above-mentioned accumulation operation is also repeated for all of the plurality of candidate offsets, and cumulative correlation values for the plurality of candidate offsets are stored in the buffer 516. The cumulative correlation values are provided to the maximum value selector 518. The maximum value selector 518 then selects the largest value (a first maximum value) and the next largest value (a second maximum value) from among the cumulative correlation values. The threshold tester 520 determines if a ratio of the second maximum value to the first maximum value is equal to or greater than a predetermined threshold, threshold_ratio. If the ratio is less than threshold_ratio, the threshold tester 520 stops the accumulation operation and outputs a candidate offset corresponding to the first maximum value as a coarse carrier frequency offset Δfₘ. However, if the ratio is not less than threshold_ratio, the threshold tester 520 determines the first maximum value as unreliable and instructs the FFT unit 502 to receive the next symbol.

The accumulator 512 performs the accumulation operation within a predetermined maximum accumulation count, ACC_CNT. That is, if the accumulator 512 fails in detecting a reliable coarse carrier frequency offset even after accumulating the correlation values for the symbols by ACC_CNT, frequency synchronization is determined as a failure.

An exemplary embodiment of the present invention as constructed above improves detection performance through soft combining performed by the accumulator 512 when the detection performance deteriorates, for example, it is under a low SNR environment, and immediately detects a coarse carrier frequency offset when the detection performance is favorable or it is under a high SNR environment. Since, under a poor SNR environment, original data is not normally restored even if data demodulation is performed, communication quality deterioration is the same to a user, although frequency synchronization is performed a little later. Thus, an initial synchronization time delay caused by soft combining is acceptable. On the contrary, under a good SNR environment, rapid frequency synchronization is performed such that data can be rapidly demodulated without delay.

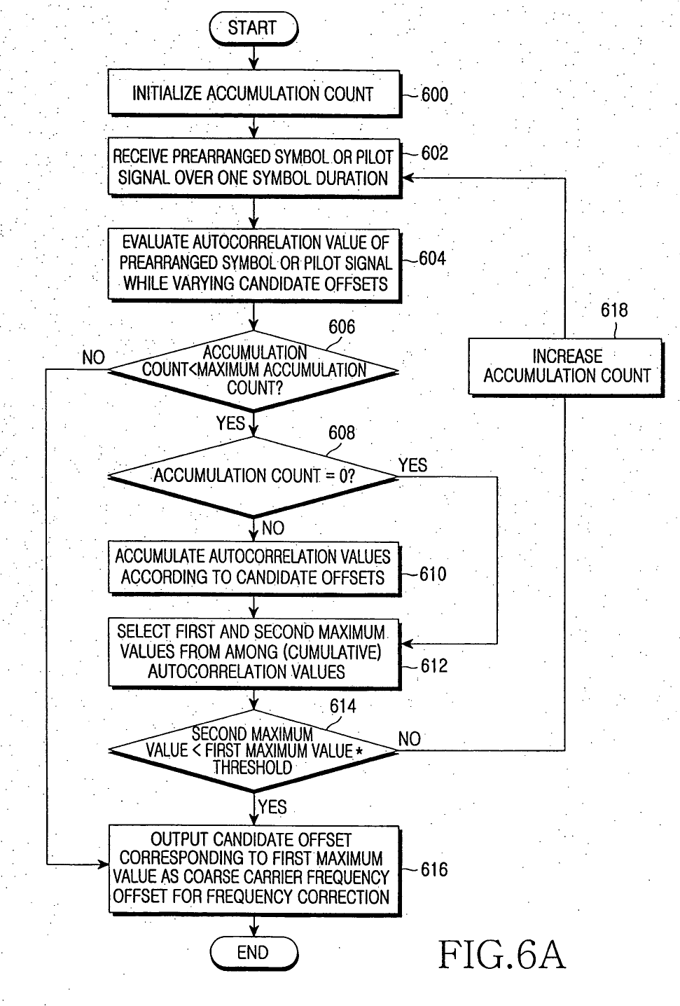

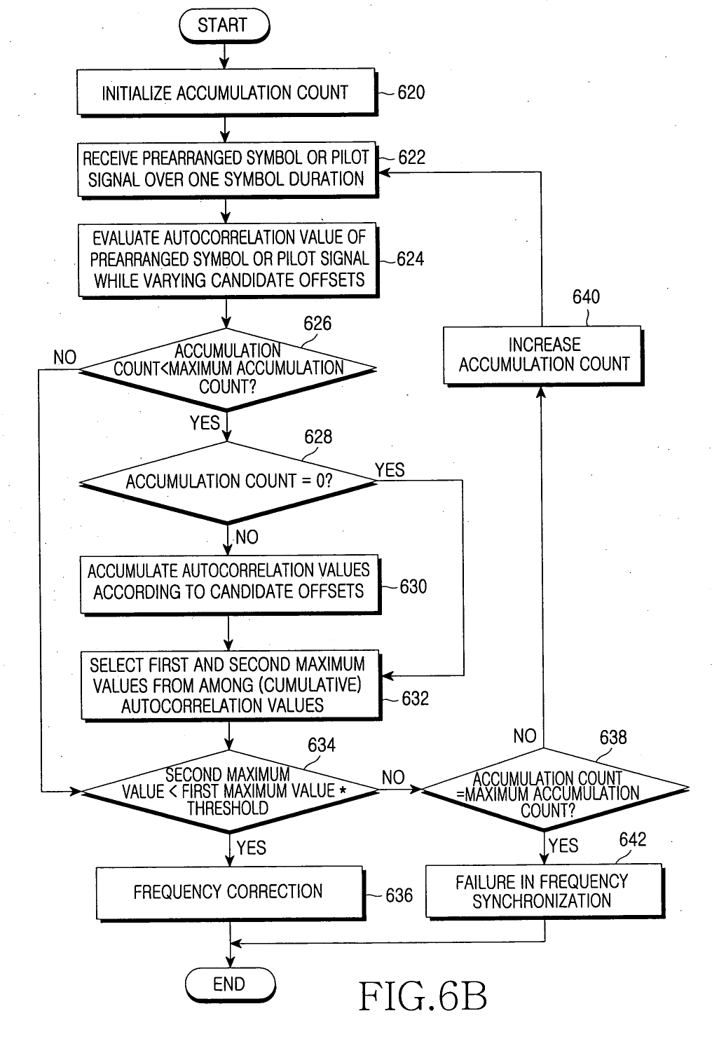

FIG. 6a illustrates a flowchart of a frequency estimation procedure according to an exemplary embodiment of the present invention.

Referring to FIG. 6a, in step 600, an accumulation count is initialized to 0. In step 602, a prearranged symbol or a pilot signal included in a received signal over one symbol duration is input into a frequency estimation apparatus, and the frequency estimation apparatus evaluates autocorrelation values of the prearranged symbol or the pilot signal for predetermined candidate offsets in step 604. In step 606, the frequency estimation apparatus determines if the accumulation count of autocorrelation values reaches a predetermined maximum accumulation count, and proceeds to step 608 if the accumulation count of autocorrelation values doesn't reach the maximum accumulation count. Otherwise, the frequency estimation apparatus proceeds to step 616.

In step 608, if the accumulation count is 0, the frequency apparatus proceeds to step 612 and selects first and second maximum values from among autocorrelation values of a received signal over a current symbol duration. However, if the accumulation count is not 0, in step 610, the frequency estimation apparatus accumulates autocorrelation values of a prearranged symbol or a pilot signal, which are evaluated for the respective candidate offsets over a next symbol duration, to autocorrelation values corresponding to a previous symbol duration, and selects first and second maximum values from among the accumulated autocorrelation values in step 612. In step 614, the second maximum value is compared with the first maximum value multiplied by a predetermined threshold. If the second maximum value is less than the first maximum value multiplied by the predetermined threshold, the frequency estimation apparatus proceeds to step 616, determines a candidate offset corresponding to the first maximum value as a coarse carrier frequency offset, and performs frequency correction, that is, frequency synchronization, by using the determined coarse carrier frequency offset. However, if the second maximum value is not less than the first maximum value multiplied by the predetermined threshold, the frequency estimation apparatus proceeds to step 618, increases the accumulation count by 1, and then returns to step 602.

The fact that the frequency estimation apparatus proceeds to step 616 if step 606 results in “NO” means that, when a maximum autocorrelation value successful in threshold testing is not obtained until the accumulation count reaches a predetermined maximum accumulation count, frequency correction is performed using a first maximum value unsuccessful in the threshold testing as a coarse carrier frequency offset. In contrast with this, another embodiment to be described below determines frequency synchronization as a failure when a maximum autocorrelation value successful in the threshold testing is not obtained until the accumulation count reaches the predetermined maximum accumulation count.

FIG. 6b illustrates a flowchart of a frequency estimation procedure according to an exemplary embodiment of the present invention.

Referring to FIG. 6b, in step 620, an accumulation count is initialized to 0. In step 622, a prearranged symbol or a pilot signal included in a received signal over one symbol duration is input into a frequency estimation apparatus, and the frequency estimation apparatus evaluates autocorrelation values of the prearranged symbol or the pilot signal for predetermined candidate offsets in step 624. In step 626, the frequency estimation apparatus determines if the accumulation count of autocorrelation values reaches a predetermined maximum accumulation count, and proceeds to step 628 if the accumulation count doesn't reach the maximum accumulation count. Otherwise, the frequency estimation apparatus proceeds to step 634.

In step 628, if the accumulation count is 0, the frequency apparatus proceeds to step 632 and selects first and second maximum values from among autocorrelation values of a received signal over a current symbol duration. However, if the accumulation count is not 0, in step 630, the frequency estimation apparatus accumulates autocorrelation values of a prearranged symbol or a pilot signal, which are evaluated for the respective candidate offsets over a next symbol duration, to autocorrelation values corresponding to a previous symbol duration, and selects first and second maximum values from among the accumulated autocorrelation values in step 632. In step 634, the second maximum value is compared with the first maximum value multiplied by a predetermined threshold. If the second maximum value is less than the first maximum value multiplied by the predetermined threshold, the frequency estimation apparatus proceeds to step 636, determines a candidate offset corresponding to the first maximum value as a coarse carrier frequency offset, and performs frequency correction, that is, frequency synchronization, by using the determined coarse carrier frequency offset.

However, if the second maximum value is not less than the first maximum value multiplied by the predetermined threshold, the frequency estimation apparatus proceeds to step 638, and determines if the accumulation count is equal to the maximum accumulation count. If the accumulation count is equal to the maximum count, the frequency estimation apparatus proceeds to step 642, and determines frequency synchronization as a failure, by which the procedure is terminated. In this case, frequency correction is not performed, and a frequency estimation procedure may begin again with a received signal over a new symbol duration according to system settings. However, if the accumulation count is not equal to the maximum count, the frequency estimation apparatus proceeds to step 640, increases the accumulation count by 1, and then returns to step 622.

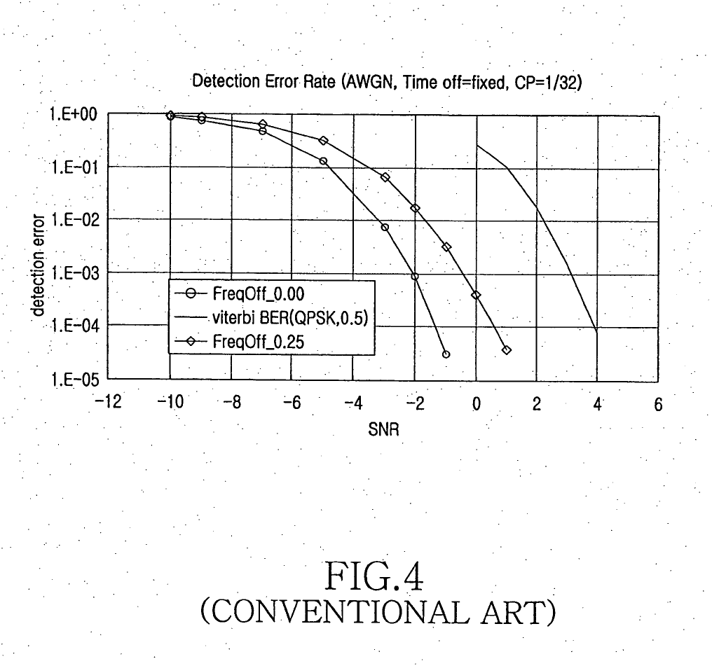

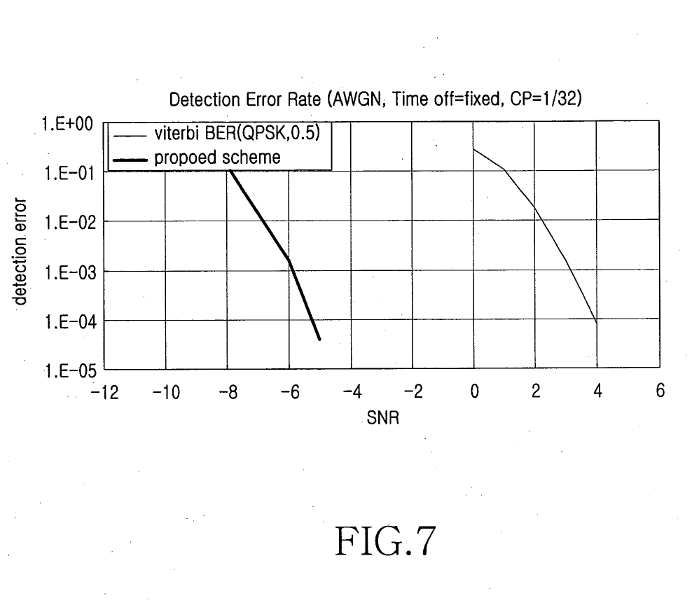

FIG. 7 illustrates the performance of detecting a carrier frequency offset when soft combining is performed eight times. Here, as in FIG. 4, using a fixed time offset and a CP with a length of 1/32 in an AWGN environment, detection performance (indicated by “proposed_scheme”) is compared with a BER obtained by QPSK modulation and viterbi decoding with a code rate of 0.5 (indicated by “viterbi BER”). It can be noted from the drawing that the detection performance of the present invention, that is, proposed_scheme, has a gain of about 10 dB over the BER, that is, viterbi BER, which represents data decoding performance, and thus has improved data decoding performance as compared with the prior art.

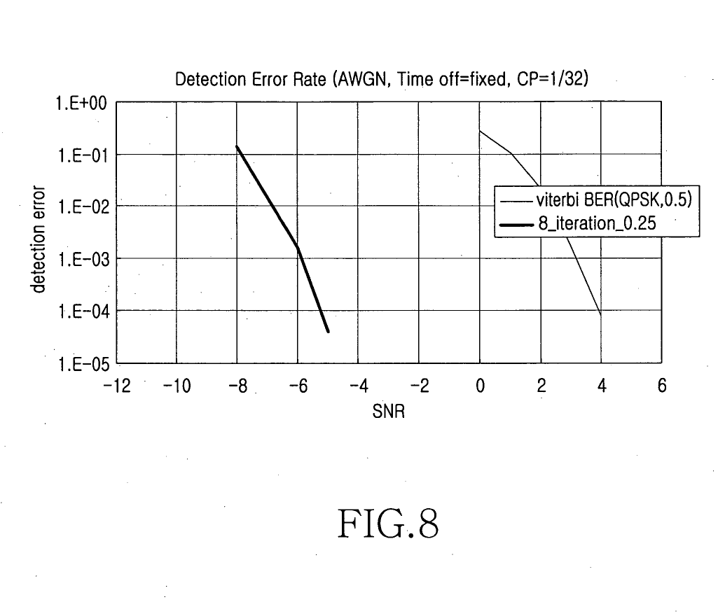

FIG. 8 illustrates the performance of detecting a carrier frequency offset when adaptive soft combining dependent on threshold testing is performed according to an exemplary embodiment of the present invention. A simulation environment is identical to those in FIGS. 4 and 7, and the number of times of performing soft combining can vary with reliability judgment based on adaptive threshold testing. Here, a threshold used for threshold testing is set to 0.7 to obtain detection performance similar to that in the case of using only soft combining. A value of 0.25 presented in the drawing denotes an actual carrier frequency offset between a transmitter and a receiver (that is, a value to be estimated). As illustrated in the drawing, when the number of times of performing soft combining varies within a maximum of eight times according to a threshold value of 0.7, the detection performance of the present invention (indicated by “8_iteration_{—}0.25”) is far better than the BER (indicated by “viterbi BER”), and is not significantly lowered as compared with that in FIG. 7.

Accordingly, an exemplary embodiment of present invention reduces an initial synchronization acquisition time and simultaneously obtains excellent detection performance by using soft combining and adaptive threshold testing together.

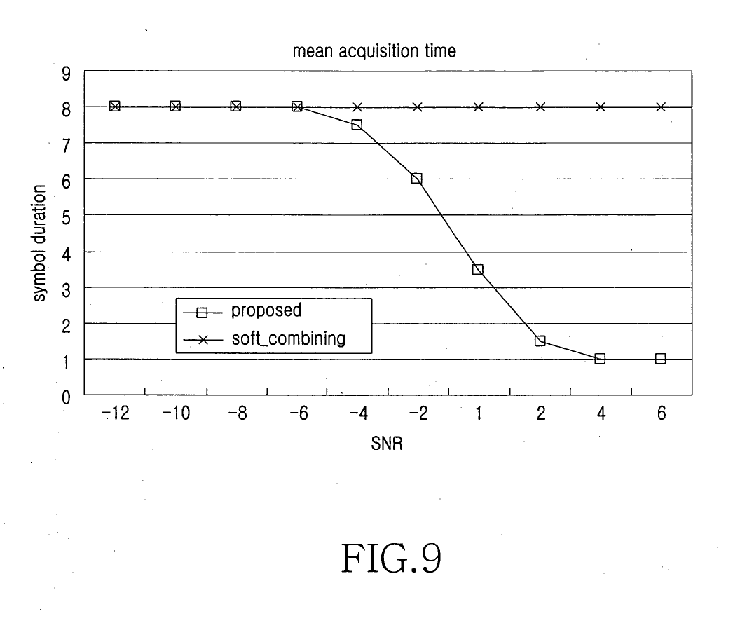

FIG. 9 illustrates a graph comparing an initial synchronization acquisition time in accordance with an exemplary embodiment of the present invention with that of a soft combining scheme. Here, the number of times of performing soft combining, that is, an accumulation count of autocorrelation values, is limited to a maximum of eight times.

As illustrated in the drawing, when soft combining is performed eight times without performing adaptive threshold testing, the initial synchronization acquisition time (indicated by “soft_combining”) always exhibits the same value, that is, a value of 8 symbol durations. The initial synchronization acquisition time of an exemplary embodiment of the present invention (indicated by “proposed”) exhibits a value of 8 symbol durations under a relatively low SNR environment of below −6 dB, which is the same as that in the case of using only soft combining. However, the initial synchronization acquisition time of the present invention decreases in inverse proportion to a SNR under a relatively high SNR environment of above −4 dB, and consequently only 1 symbol duration is required for acquiring initial synchronization under an SNR environment of above 4 dB.

According to an exemplary embodiment of the present invention as describe above, in estimating an initial carrier frequency offset necessary for performing a frequency synchronization algorithm, detection performance is improved by accumulating autocorrelation values of a prearranged symbol or a pilot signal detected from a received signal up to a predetermined maximum accumulation count. Further, under a high SNR environment or when detection performance is good, accumulating autocorrelation values are stopped through threshold testing for a ratio between first and second maximum values selected from among autocorrelation values corresponding to candidate offsets, so that a time delay in frequency synchronization detection is minimized.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for estimating a coarse carrier frequency offset in an Orthogonal Frequency Division Multiplexing (OFDM) receiver, the apparatus comprising:
a Fast Fourier Transform (FFT) unit for receiving a signal corresponding to one symbol, fast Fourier transforming the received signal, and outputting a previously known signal included in the fast Fourier transformed signal;
a correlation value calculator for applying a plurality of candidate offsets to the previously known signal to evaluate autocorrelation values of the previously known signal for the candidate offsets;
an accumulator for accumulating the evaluated autocorrelation values to autocorrelation values, which have been evaluated for the candidate offsets over a previous symbol duration, within a maximum accumulation count;
a maximum value selector for selecting a first maximum value and a second maximum value from the accumulated autocorrelation values; and
a threshold tester for comparing a ratio of the second maximum value to the first maximum value with a reference threshold, determining a candidate offset corresponding to the first maximum value as the coarse carrier frequency offset if the ratio is less than the threshold, and instructing the FFT unit to receive a signal over a next symbol duration if the ratio is not less than the threshold.

2. The apparatus as claimed in claim 1, wherein, if an accumulation count of the previously known signal reaches the maximum accumulation count, the threshold tester determines a candidate offset corresponding to a first maximum value of autocorrelation values accumulated by the maximum accumulation count as the coarse carrier frequency offset.

3. The apparatus as claimed in claim 1, wherein, if an accumulation count of the previously known signal reaches the maximum accumulation count, the threshold tester determines a failure in estimating the coarse carrier frequency offset.

4. The apparatus as claimed in claim 1, wherein the previously known signal comprises at least one of a prearranged symbol and a pilot signal.

5. The apparatus as claimed in claim 1, wherein the correlation value calculator comprises:
a delayer for storing a previously known signal detected from a received signal corresponding to a previous symbol, during one symbol duration;
a multiplier for correlating the previously known signal corresponding to the previous symbol stored in the delayer, with the previously known signal output from the FFT unit;
an adder for adding up outputs for a plurality of sub-carrier bands output from the multiplier, and generating an added-up value; and
an absolute value calculator for evaluating a magnitude of the added-up value and outputting the evaluated magnitude as the autocorrelation value.

6. The apparatus as claimed in claim 1, wherein the accumulator comprises:
an adder for adding the autocorrelation values output from the correlation value calculator, to autocorrelation values corresponding to a previous symbol according to the candidate offsets; and
a buffer for storing the respective added autocorrelation values and providing the stored values as cumulative autocorrelation values to the maximum value selector.

7. A method for estimating a coarse carrier frequency offset in an Orthogonal Frequency Division Multiplexing (OFDM) receiver, the method comprising the steps of:
receiving a signal corresponding to one symbol, fast Fourier transforming the received signal, and detecting a previously known signal included in the fast Fourier transformed signal;
applying a plurality of candidate offsets to evaluate autocorrelation values of the previously known signal for the candidate offsets;
accumulating the evaluated autocorrelation values to autocorrelation values, which have been evaluated for the candidate offsets over a previous symbol duration, within a maximum accumulation count;
selecting a first maximum value and a second maximum value from the accumulated autocorrelation values, and determining if a ratio of the second maximum value to the first maximum value is less than a reference threshold;
if the ratio is less than the threshold, determining a candidate offset corresponding to the first maximum value as the coarse carrier frequency offset; and
if the ratio is not less than the threshold, returning to the receiving of the signal over a next symbol duration.

8. The method as claimed in claim 7, further comprising, if an accumulation count of the previously known signal reaches the maximum accumulation count, determining a candidate offset corresponding to a first maximum value of autocorrelation values accumulated by the maximum accumulation count as the coarse carrier frequency offset.

9. The method as claimed in claim 7, further comprising, if an accumulation count of the previously known signal reaches the maximum accumulation count, determining a failure in estimating the coarse carrier frequency offset.

10. The method as claimed in claim 7, wherein the previously known signal comprises at least one of a prearranged symbol and a pilot signal.

11. An apparatus for estimating a coarse carrier frequency offset in an Orthogonal Frequency Division Multiplexing (OFDM) receiver, the apparatus comprising:
a maximum value selector for selecting a first maximum value and a second maximum value from accumulated autocorrelation values; and
a threshold tester for comparing a ratio of the second maximum value to the first maximum value with a reference threshold, determining a candidate offset corresponding to the first maximum value as the coarse carrier frequency offset if the ratio is less than the threshold, and instructing a Fast Fourier Transform (FFT) unit to receive a signal over a next symbol duration if the ratio is not less than the threshold.

12. The apparatus of claim 1, wherein the FFT unit receives a signal corresponding to one symbol, fast Fourier transforming the received signal, and outputting a previously known signal included in the fast Fourier transformed signal.

13. The apparatus of claim 12, further comprising a correlation value calculator for applying a plurality of candidate offsets to the previously known signal to evaluate autocorrelation values of the previously known signal for the candidate offsets.

14. The apparatus of claim 13, further comprising an accumulator for accumulating the evaluated autocorrelation values to autocorrelation values, which have been evaluated for the candidate offsets over a previous symbol duration, within a maximum accumulation count.

15. The apparatus as claimed in claim 14, wherein, if an accumulation count of the previously known signal reaches the maximum accumulation count, the threshold tester determines a candidate offset corresponding to a first maximum value of autocorrelation values accumulated by the maximum accumulation count as the coarse carrier frequency offset.

16. The apparatus as claimed in claim 14, wherein, if an accumulation count of the previously known signal reaches the maximum accumulation count, the threshold tester determines a failure in estimating the coarse carrier frequency offset.

17. The apparatus as claimed in claim 12, wherein the previously known signal comprises at least one of a prearranged symbol and a pilot signal.

18. The apparatus as claimed in claim 13, wherein the correlation value calculator comprises:
a delayer for storing a previously known signal detected from a received signal corresponding to a previous symbol, during one symbol duration;
a multiplier for correlating the previously known signal corresponding to the previous symbol stored in the delayer, with the previously known signal output from the FFT unit;
an adder for adding up outputs for a plurality of sub-carrier bands output from the multiplier, and generating an added-up value; and
an absolute value calculator for evaluating a magnitude of the added-up value and outputting the evaluated magnitude as the autocorrelation value.

19. The apparatus as claimed in claim 14, wherein the accumulator comprises:
an adder for adding the autocorrelation values output from the correlation value calculator, to autocorrelation values corresponding to a previous symbol according to the candidate offsets; and
a buffer for storing the respective added autocorrelation values and providing the stored values as cumulative autocorrelation values to the maximum value selector.
